(19) United States
(12) Patent Application Publication
(10) Pub. No.: US 2016/0103220 A1
(43) Pub. Date: Apr. 14, 2016

(54) SYSTEMS, DEVICES, AND METHODS TO DETERMINE STATISTICS OR METRICS RELATING TO PLAYER PERFORMANCE

(71) Applicant: Quark Industries, Palm Bay, FL (US)

(72) Inventor: Justin Ramsaran, Palm Bay, FL (US)

(21) Appl. No.: 14/598,754

(22) Filed: Jan. 16, 2015

Related U.S. Application Data
(60) Provisional application No. 62/062,206, filed on Oct. 10, 2014.

(51) Int. Cl. G01S 15/66

(52) U.S. Cl. CPC G01S 15/66

(57) ABSTRACT

The present invention is direction to systems and methods of determining statistics or metrics relating to player performance in a sporting event. Preferred systems herein comprise (a) an object device affixed to a sports object wherein the object device includes one or more object sensors; (b) a player device affixed to at least one of a player and a player sports equipment wherein the player device includes one or more player sensors; (c) wherein the object device: (i) detects the player device using the one or more object sensors and one or more player sensors; (ii) acquires player information from the player device.

### CROSS-REFERENCE TO RELATED APPLICATIONS

This application claims priority to U.S. Provisional Application No. 62/062,206, titled Systems, Devices, and Methods to Determine Statistics or Metrics Relating to Player Performance, filed Oct. 10, 2014, which is expressly incorporated by reference in its entirety.

### BACKGROUND

As technology evolves, innovators apply evolving technology in different arenas to provide improvements. One area where developing technology is applied is in the sports arena (literally and figuratively). Sensor technology has evolved such that sensors can track ball and/or ball movement thereby allowing for determination of statistics and metrics related to player performance.

In one example of conventional sensor technology to record ball movement is a smart soccer ball. Such technology can be used to measure ball trajectories as well as be used in conjunction with external sensor technology to determine goal scoring. Another example includes external camera and/or sensors placed in a geometric configuration around a field of play that tracks player movement. Such a sensor system may record the number of meters a player runs during a match or other statistics and metrics related to player performance.

However, none of the conventional sensor technologies applied to sports involve sensors affixed to a player. Further, none of the conventional sensor technologies have sensors affixed to players interacting with sensors affixed to a ball.

There is current technology using a “sweep signal” along with a VLSi Radio frequency system. This system acts as a sonar detection system where it constantly is detecting users or RFID tags on the field of play at the time of instantaneous movements. The chirp signal in this sweep system allows for the transmitted signal to locate a player along the specific variable axis. This allows for the signal from an outside signaling system to transmit location with outside usage of large scale antenna. The use of a sweep frequency of the sweep signal changes in accordance with a predetermined pattern. With this location detection pattern, the system allows for the implemented usage of the said signaling system to now determine the players spatially on the field.

Accordingly, there is a need for systems, devices, and methods to determine statistics or metrics relating to player performance in an interactive sensor system. That is, the interactive sensor system includes sensors affixed to a player interacting with sensors in a ball.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of sensor and its data processing capabilities in accordance with some embodiments.

FIG. 2 is a block diagram of a sensor system and its data transmission and storage capabilities in accordance with some embodiments.

FIG. 3 is a block diagram of a wireless charging system in accordance with some embodiments.

FIG. 4 is a block diagram of an active circuitry design in accordance with some embodiments.

FIG. 5 is a block diagram of a sensor system's RFID/NFC transmission capabilities in accordance with some embodiments.

FIG. 6 is a block diagram of a logic flow of the RFID/NFC transmission in accordance with some embodiments.

FIG. 7 is a flowchart of a data flow of the sensor system in accordance with some embodiments.

FIG. 8 is a flowchart of a data acquisition flow of the sensor system in accordance with some embodiments.

FIG. 9 is a flowchart of a RFID/NFC logic flow of the sensor system in accordance with some embodiments.

FIG. 10 is a flowchart of a spatial location flow of the sensor system in accordance with some embodiments.

FIG. 11 is a block diagram of a data acquisition of the sensor system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”.

The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure describe systems, devices, and methods to determine statistics or metrics relating to player performance in an interactive sensor system. That is, the interactive sensor system includes sensors affixed to a player interacting with sensors in a ball. In one embodiment, sensors may be placed in the gloves or pads of football players as well as a sensor in the football. During play, player sensors may interact with the ball sensor. Further, the data acquired by player sensors and ball sensor, including the interaction of the sensors, may be uploaded to an external (cloud) system for data processing. In addition, the player sensor and ball sensor data is processed to determine statistics or metrics relating to player performance. For example, ball trajectory and player movement may be calculated to determine whether a receiver in the vicinity of the ball dropped a pass. In another example, the ball trajectory and player movement may be calculated to determine whether a defensive player batted a ball away leading to the receiver's inability to catch the ball.

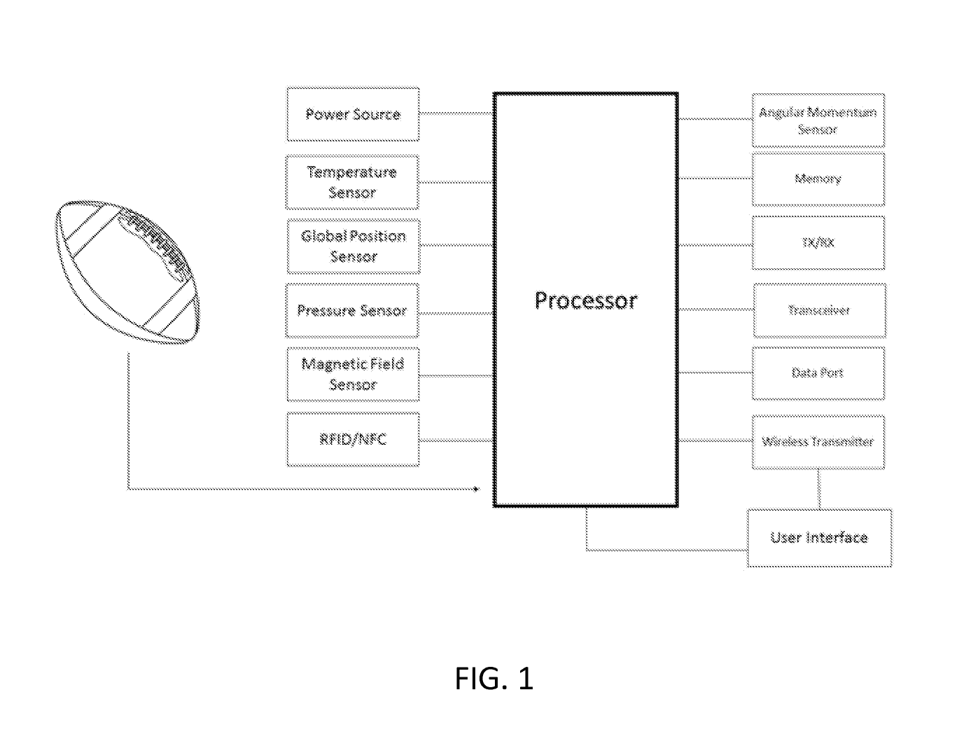

FIG. 1 is a block diagram of sensor and its data processing capabilities in accordance with some embodiments. In one embodiment, the sensor may be placed in a football. The sensor may include several components that include, but is not limited to power source, temperature sensor, global positions sensor, pressure sensor, magnetic field sensor, RFID/NFC (Radio Frequency Identification/Near Field Communications) module, angular momentum sensor, memory module, TX/RX (transmit/receive communication module), transceiver, data port, wireless transmitter, and user interface.

Note, the term “sensor” in the present disclosure may describe a single a sensor such as in a “temperature sensor” but also may refer to a collection of individual sensors as shown in FIG. 1, for example. Further, a sensor may include a reader or a tag as referred to RFID/NFC technology. Also, although some of the embodiments describe systems, devices, and methods of the present disclosure that are associated with football and football players, persons of ordinary skill in the art would understand that the systems, devices, and methods of the present disclosure can be associated with players and/or balls (or other sports equipment) of other sports. In addition, the sensor shown in FIG. 1 may be used in conjunction with sensor(s) or tag(s) affixed to a football player (e.g. the sensor(s) or tag(s) may be affixed to the glove or pads of a football player). A tag is a communication device that is used in RFID/NFC and is read by a reader when in close proximity to the tag.

The power source may be a rechargeable (or disposable) battery. Further, the temperature sensor measures ambient temperature of the ball that can be used to calculate statistics or metrics related to player performance In addition, the global positioning (GPS) sensor communicates with global positioning system (GPS) satellite(s) to determine a location (e.g. longitude and latitude) of the football. That is, the global position sensor uses space-based satellite navigation system that provides location and time information in all weather conditions, anywhere on or near the Earth where there is an unobstructed line of sight to four or more GPS satellites to determine the location of the ball. The implementation of GPS allows for the positioning of the object (e.g. football) to be located on a 2D/3D grid which then maps for specific location within a range of 2 meters.

The pressure sensor may measure air pressure or the pressure of other gases or liquids in other embodiments. Pressure is an expression of the force required to stop a fluid from expanding, and is usually stated in terms of force per unit area. A pressure sensor usually acts as a transducer. That is, it generates a signal as a function of the pressure imposed such as an electrical signal. Pressure sensors are used for control and monitoring in thousands of everyday applications. Pressure sensors can also be used to indirectly measure other variables such as fluid/gas flow, speed, water level, and altitude.

The pressure sensor measures the barometric pressure to determine when an object (e.g. football) experiences elevation change. Based on the differential pressures on the inside and the outside of the object, when a change occurs it allows for the initial pressure to be calculated versus the final pressure then giving an altitude reading which correlates accordingly to the object's movement. The pressure sensor in the football sensor may be used to determine the speed and altitude of the football thereby calculating its trajectory. With the incorporation of the pressure sensor the ability not only to measure the altitude of the pitch of football (e.g. object), the overall device itself can utilize the technology to allow for the ability to adapt to fluid dynamic changes of pressure that can occur within an object or outside depending on the spatial orientation of it. The utilization of the pressure sensor as described herein are based upon core scientific principles.

The magnetic field sensor may have different purposes in different embodiments. One purpose may be to facilitate Near Field Communications (NFC). That is, the sensor in a football can read information from a sensor in a glove or pad of a football player using the magnetic field sensor. Another purpose for the magnetic field sensor may be charging the rechargeable battery using electromagnetic induction as described in the present disclosure.

The RFID/NFC module is used to identify and communicate with a tag affixed to a football player (via gloves or pads). The tag may wirelessly or in a non-contact manner transfer data to the football sensor using the RFID/NFC module. Such data may be used to identify or track the tag on the football player. Further, the tags contain electronically stored information. Some tags are powered by and read at short ranges (a few meters) via magnetic fields (electromagnetic induction). Other tags use a local power source such as a battery, or else have no battery but collect energy from the interrogating EM field, and then act as a passive transponder to emit microwaves or UHF radio waves (i.e., electromagnetic radiation at high frequencies). Battery powered tags may operate at hundreds of meters. Unlike a barcode, the tag does not necessarily need to be within line of sight of the reader, and may be embedded in a tracked object (e.g. glove, pads, etc.).

As a person or ordinary skill in the art would understand, NFC is a set of short-range wireless technologies, typically requiring a distance of 10 cm or less. NFC operates at 13.56 MHz on ISO/IEC 18000-3. NFC always involves an initiator and a target; the initiator actively generates an RF field that can power a passive target. This enables NFC targets to take very simple form factors such as tags, stickers, key fobs, or cards that do not require batteries. In one embodiment, the initiator may be sensor/reader in the football and the passive target may be the tag affixed to a player glove or pads.

NFC peer-to-peer communication is possible, provided both reader and tag are powered and there is a transceiver and receiver. The sensor in the football may include an RFID chip set that facilitates RFID/NFC between the football sensor/reader and the tag in the player glove or pads. NFC is a specific segment of RFID itself and deals with the sending and receiving of the data this means RFID detects the tag ID and NFC handles/manages data communications.

In one embodiment, there may be a player that has an RFID tag affixed to a player's gloves or pads. When the gloves and or pads come in contact with the football having a sensor/reader as shown in FIG. 1, the football can communicate to the tag. The tag then communicates with the football, the player tag's UUID (Universally Unique Identifier) is transmitted to the football sensor/reader which then transmits the data to a computer application residing on a user computing device or cloud computer system via Bluetooth or other wireless technologies. Such data received by the computer application or cloud system may be further processed and analyzed to determine individual player statistics or metrics related to player performance.

The RFID/NFC communication system between the football sensor/reader and the tag affixed to the football player is sensitive to detect players contact with the ball directly via gloves and or pads. When multiple players and hence multiple tags are near the reader of the football simultaneously, there is no interference communication with one tag by the reader to another tag because each tag has its own UIUD. Further, player contact with the ball is determined with a variable time. If a player comes into contact with the ball for e.g. 1/100 of a second the reader of the football does not read as anything specific from the tag affixed to the player. For example, when a linebacker strips the football, and both players are in a phase of entanglement, the data processing and analysis by the cloud computing system may register a null state. However, the player who then pulls out with the ball then is registered as strip/turnover for the game play. Then the UIUD of the tag of the first player who had possession of the football and was record by the football sensor/reader is replaced by the UUID of the tag of the second player who gained possession of the football from the turnover.

RFID is incorporated with the NFC as is used in the identification system for each individual user/player. Player names/identities (e.g. jersey numbers) are generated and setup in a database then each player is assigned a specific UUID number for referencing. Each UUID is recorded in a tag. The tag utilizes a series of transmission signals along with backscatter signals to allow for wireless transmission and communication between the transceiver and receiver from the external and internal sensors. The internal sensors are comprised of the RFID, NFC, and the Bluetooth sensors. These internalized sensors allow for the processed data to either be received and or transmitted to an outside device. The external sensors include but aren't limited to the RFID tag system, which may be outside of the internalized active circuitry, that can communicate with the internal sensors, through transfer/receive protocol unique to the DAPS system.

Contrary to the present invention, there is current technology that utilizes a “sweep signal” along with a VLSi Radio frequency system. This system acts as a sonar detection system where it is constantly detecting user or RFID tags on the field of play at the time of instantaneous movements. The chirp signal in this sweep system allows for the transmitted signal to locate a player along the specific variable axis. This allows for the signal from an outside signaling system to detect and transmit the location with outside usage of large “sweep signal”. The use of a sweep frequency is the sweep signal's changes in accordance with a predetermined pattern. With this location detection pattern, the system allows for the implemented usage of the said signaling system to now determine the players spatially on the field.

In contrast to this current technology, the present invention utilizes the RFID as a signal receiver and transmitter that detects the geo-location of the ball along with identifying the players integration with the ball on the field of play with the newly developed DAPS system. The present invention allows for the sports object, or ball, itself to receive data from the player and to transmit data to a secondary computing device.

In addition to the RFID/NFC communication module, the football sensor includes an angular momentum sensor. Such an angular momentum sensor may include a gyroscope and accelerometer. A gyroscope is a device for measuring or maintaining orientation, based on the principles of angular momentum. Mechanical gyroscopes typically comprise a spinning wheel or disc in which the axle is free to assume any orientation. Although this orientation does not remain fixed, it changes in response to an external torque much less and in a different direction than it would with the large angular momentum associated with the disc's high rate of spin and moment of inertia. The device's orientation remains nearly fixed, regardless of the mounting platform's motion, because mounting the device in a gimbal of the gyroscope minimizes external torque.

An accelerometer is a device that measures proper acceleration of an object (e.g. football). The proper acceleration measured by an accelerometer is not necessarily the coordinate acceleration (rate of change of velocity). Instead, the accelerometer sees the acceleration associated with the phenomenon of weight experienced by any test mass at rest in the frame of reference of the accelerometer device.

The accelerometer/gyroscope is combined in angular momentum sensor. Data collected from the angular momentum sensor issued for specific vector calculations that allow for spatial orientation within a 3D environment. The 10 DOF (Degrees of Freedom) allows for the objects orientation to give readings on the angular momentum along with spin rotation and inertia.

The memory module may be any type of memory module known in the art including may include electronic memory, optical memory, and removable storage media.

The TX/RX module allows for the sensor to transmit and receive date to and from any external devices including a cloud computing system, computer application, or one or more tags. The transceiver may work in conjunction with the TX/RX module or not to communicate with any external devices including a cloud computing system, computer application, or one or more tags. The data port may be used to access data stored in the memory module or to configure the sensor. The wireless transmitter may include an antenna and may work in conjunction with the TX/RX module or not to communicate with any external devices including a cloud computing system, computer application, or one or more tags. Such protocols used by the wireless transmitter may include Bluetooth, WiFi, etc. It can be the main source in which data transmission occurs between the externalized systems along with the internal active circuitry. The data is transmitted with various protocols be it WiFi, 3G, and or Bluetooth. The user interface allows for a user or administrator to access data or configure the sensor to collect data and transmit such data to a cloud computing system. Within the user interface the development of software that can take the data which is sent from the wireless transmission system and port it into a GUI (Graphical User Interface) that displays the data for users in a more systemic format. The development of a mobile application, and/or desktop interface may be created. With the user interface, the dynamic may allow easier interaction for any user demographic to be able to operate the complex data which is ported to the said device. The TX/RX module is the main bus where all the protocols of the external transmitter/receiver and the internal transmitter/receiver may be proceeded in order to organize the data effectively. The transceiver within the device utilizes a transmitter and a receiver which are combined and share common circuitry. This is where the main information can be transferred between the external and internalized sensors. The onboard internalized data port, is used for the input of data to the device to be uploaded with custom firmware that is used for communication and so. Each embodiment described herein is developed uniquely for the application of said device. The operations which are entailed can be reviewed and be back by all basic core engineering principles which were involved in the development of this.

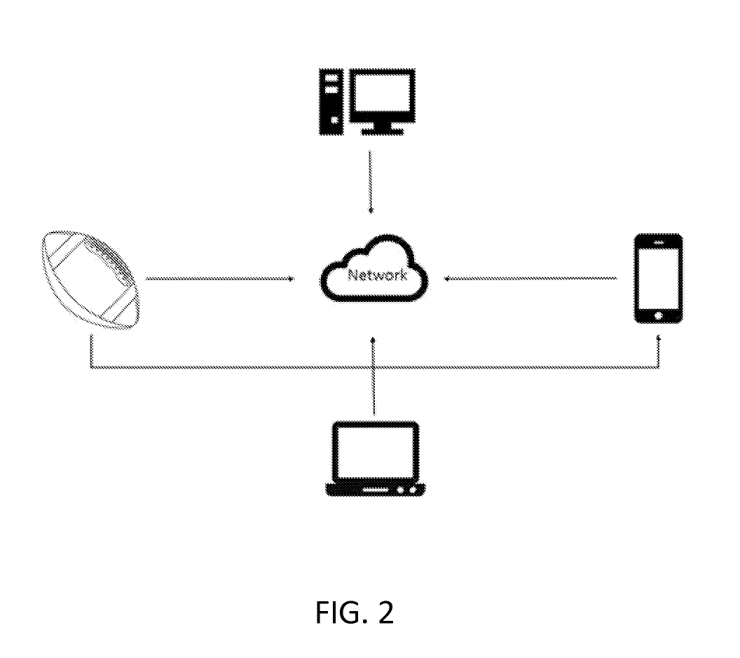

FIG. 2 is a block diagram of a sensor system and its data transmission and storage capabilities in accordance with some embodiments. As discussed in the present disclosure, the sensor in the football may transmit data to a remote or cloud computing system that includes one or more computer servers that receives data from the football sensor. Such sensor data is processed and player statistics or metrics related to player performance are determined The data sensor may be transmitted over a wireless network such as a mobile phone network, WiFi network, WiMAX network, or any other wireless network known in the art. The one or more computer servers may then provide calculated player statistics and metrics to computer applications residing in user devices such as laptop computers, table computers, and/or smartphones.

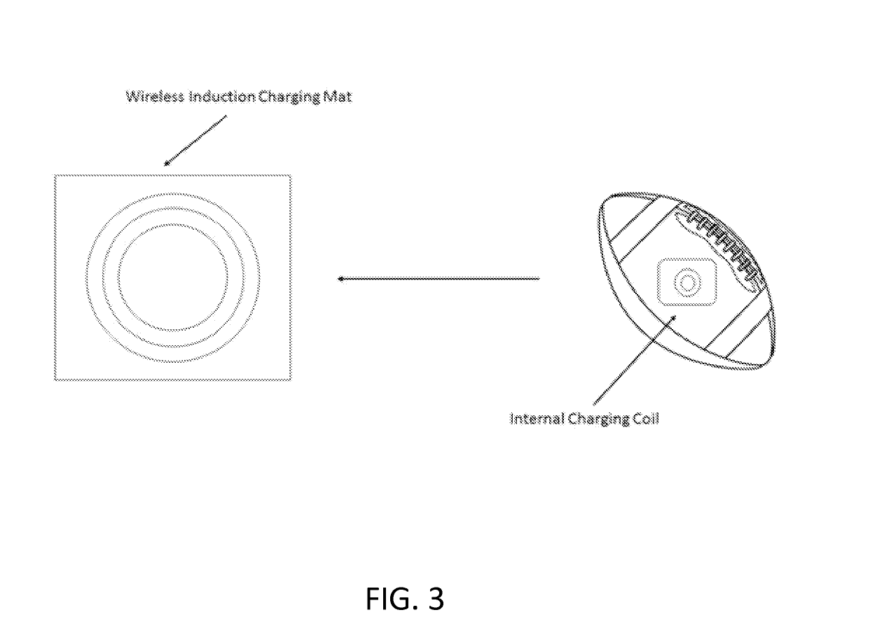

FIG. 3 is a block diagram of a wireless charging system in accordance with some embodiments. The football sensor may include a rechargeable battery as a power source. Such a rechargeable battery may be recharged using inductive charging. Inductive charging (also known as “wireless charging”) uses an electromagnetic field to transfer energy between two objects. This is usually done with a charging station. Energy is sent through an inductive coupling to an electrical device, which can then use that energy to charge batteries or run the device. Induction chargers typically use an induction coil to create an alternating electromagnetic field from within a charging base station, and a second induction coil in the portable device takes power from the electromagnetic field and converts it back into electrical current to charge the battery. The two induction coils in proximity combine to form an electrical transformer. Greater distances between sender and receiver coils can be achieved when the inductive charging system uses resonant inductive coupling. FIG. 3 shows inductive charging of the battery within a football sensor using a wireless induction charging mat and an internal charging coil within the football sensor.

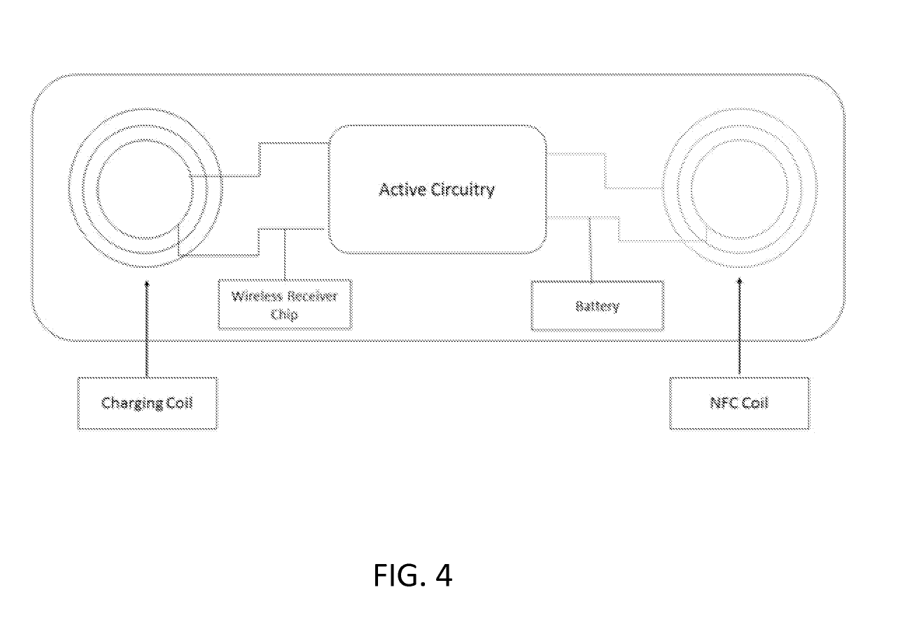

FIG. 4 is a block diagram of an active circuitry design in accordance with some embodiments. The active circuitry of the football sensor may be coupled to two coils, a charging coil used in inductively charging the battery of the football sensor and an NFC coil used in communicating with a tag affixed to player through gloves or pads and the wireless receiver chip.

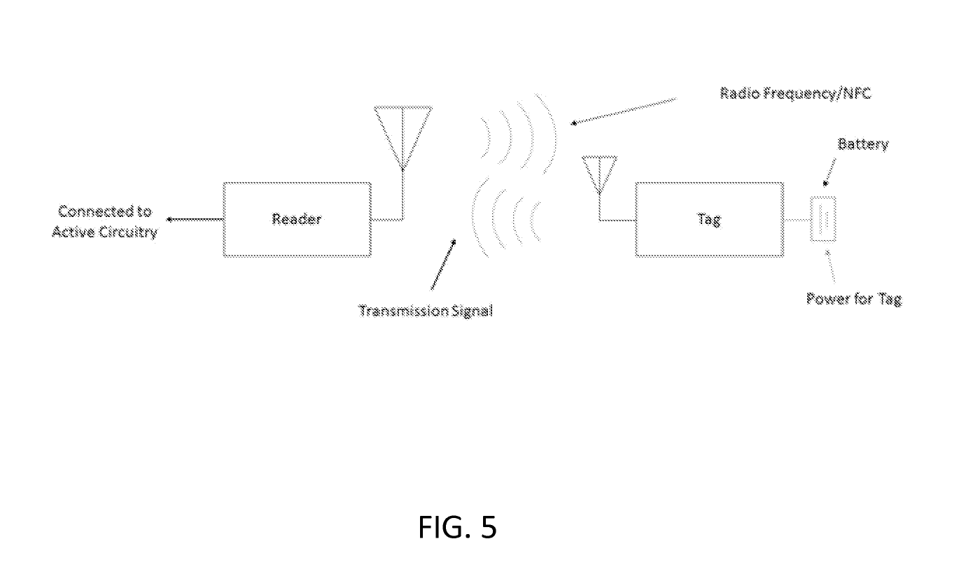

FIG. 5 is a block diagram of a sensor system's RFID/NFC transmission capabilities in accordance with some embodiments. The football sensor includes the active circuitry as well as a reader to read data from a tag affixed to player through its gloves or pads. The reader may transmit a signal through an antenna to the tag using RFID/NFC protocols and standards. Further, such transmission signals may provide power or charge the battery of the tag. Upon being placed in operation, the tag may provide data to the reader including its UIUD.

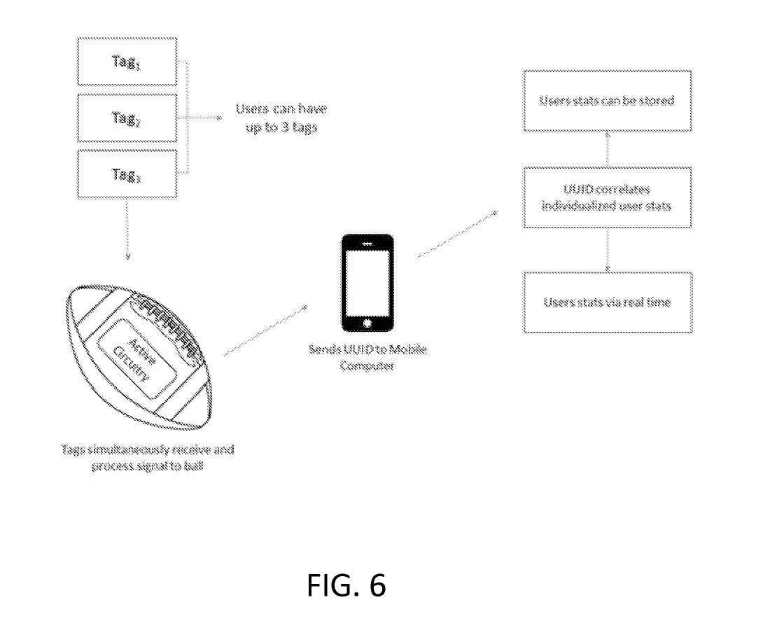

FIG. 6 is a block diagram of a logic flow of the RFID/NFC transmission in accordance with some embodiments. The football sensor can detect a tag using RFID/NFC communication protocols and standards. A player may have one or more tags associated with him/her (in this embodiment, a player may have up to three tags). Upon detecting each tag and receiving the tag's UIUD, the football sensor can send this data as well as various sensor data to a cloud or mobile computing system to calculate a player's/user's statistics or metrics and send them to a user device such as a smartphone. Such user devices can store user statistics and metrics, the UIUD correlates individualized user statistics or metrics and users may view statistics or metrics via real time. Note, in some embodiments, users may include player coaches or other team personnel.

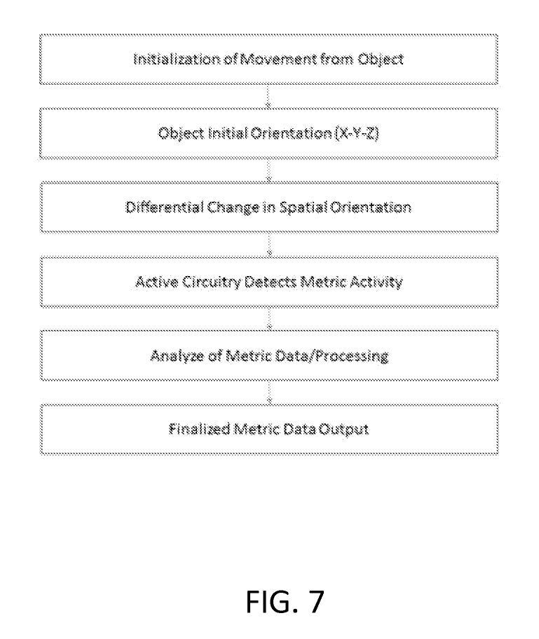

FIG. 7 is a flowchart of a data flow of the sensor system in accordance with some embodiments. Such a data flow may be associated with the data collected from a football sensor as described in the present disclosure. In a first step of the data flow, an initialization of movement from the object (e.g. football) may be recorded. In a second step of the data flow, an object initial orientation may be determined In a third step of the data flow, data may be collected by the object sensor and a differential change in the spatial orientation of the object may be determined Further, in a fourth step in the data flow, active circuitry within the object may detect metric activity. In addition, a fifth step in the data flow, analysis and processing of the metric data may be performed. Moreover, in a sixth step, metric data output may be finalized.

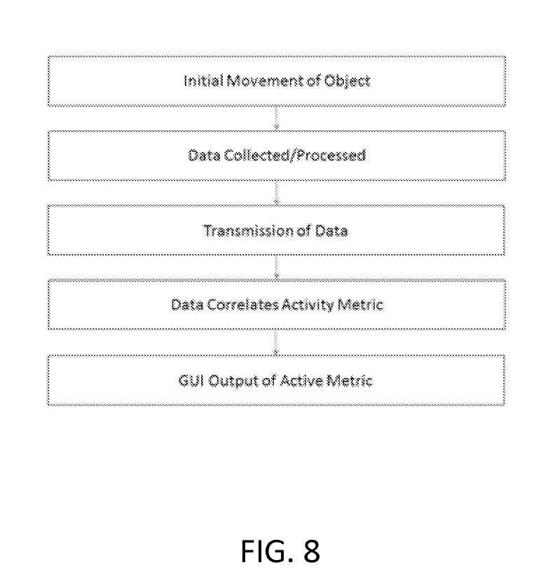

FIG. 8 is a flowchart of a data acquisition flow of the sensor system in accordance with some embodiments. Such a data acquisition flow may be associated with the data collected from a football sensor as described in the present disclosure. In a first step of the data acquisition flow, initial movement of the object (e.g. football) may be determined In a second step of the data acquisition flow, data may be collected and processed by the object sensor. In a third step in the data acquisition flow, the data is transmitted. In a fourth step of the data acquisition flow, data is correlated to an activity metric. In a fifth step of the data acquisition flow, a graphical user interface displays or outputs the activity metric.

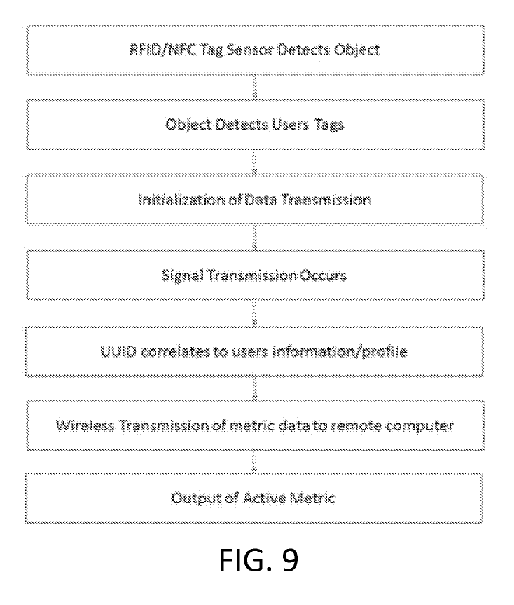

FIG. 9 is a flowchart of a RFID/NFC logic flow of the sensor system in accordance with some embodiments. In a first step in the logic flow, the RFID/NFC tag (e.g. affixed to a player) detects an object (e.g. football). In a second step in the logic flow, the object detects users' tags. In a third step in the logic flow, the tag(s) initialize data transmission. In a fourth step in the logic flow, signal transmission from the tag(s) to the reader in the object occurs. Such signal transmission includes data such as the UUID associated with the tag/player. In a fifth step of the logic flow, the UUID is correlated to user's information/profile. In a sixth step of the logic flow, wireless transmission of metric data to a remote computer system is performed. In a seventh step of the logic flow, output of active metric is provided.

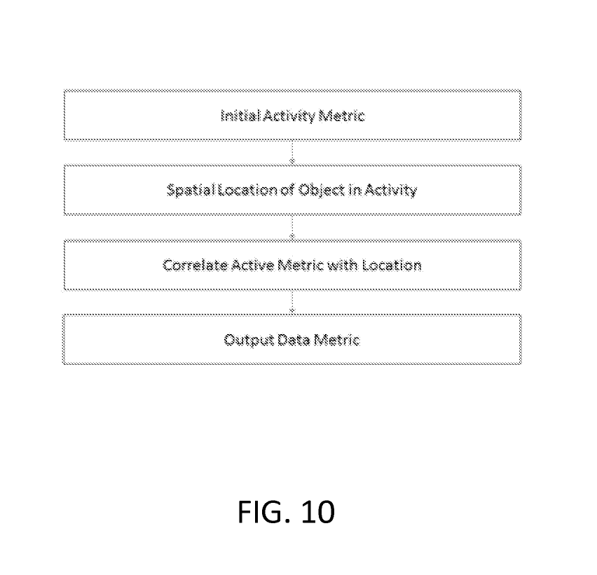

FIG. 10 is a flowchart of a spatial location flow of the sensor system in accordance with some embodiments. In a first step of the location flow, initial activity metric is determined The activity metric is the initial phase where all the first set of data begins. Based on the field of play, and how the calibration is done the active circuitry can begin to collect the data to stabilize and create constant level to allow for variability to be decreased. In a second step of the location flow, spatial location of the object in the activity is determined Once the object is moved on from the first step. The spatial orientation in which the object is in can be viewed from the various sensors data which is outputted. Once the orientation is calculated it moves on to create and allow for a dimensionally proportional view on a computer generated diagram. In a third step of the location flow, the active metric is correlated with the location. The active circuitry can take the data from the spatial location and everything else after the data phase has ended. Once ended the data can be transmitted back to the externalized computer for data analysis. In a fourth step of the location flow, data metric is outputted. The data metric is finalized at the end phase where data which is transmitted has been computed and analyzed. From there it is taken and displayed to the externalized computer, where user can access data source types based upon the metric in which has been requested from the original data start phase.

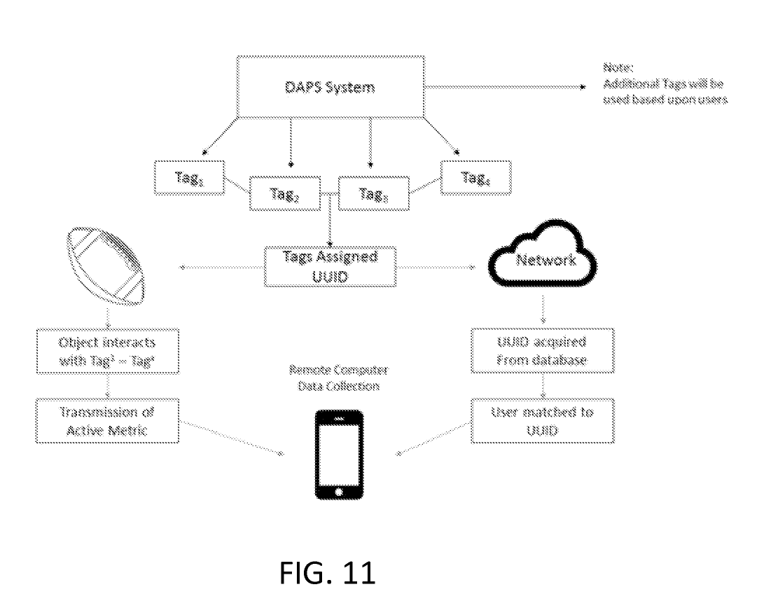

FIG. 11 is a block diagram of a data acquisition of the sensor system in accordance with some embodiments. Such a sensor system includes a data acquisition passing system (DAPS). The DAPS interacts with one or more tags. Each tag is assigned an UUID. However, in some embodiments, each tag may be associated with different UUID, but in some other embodiments two or more tags can be associated with the same UIUD. Further a UUID is associated with a player/user. A football sensor interacts with one or more tags and such a football sensor acquires the UUID(s) of the tag(s) to determine an active metric. Further, the UUID(s) are transmitted to a remote, cloud computing system that determines user(s) associated with the UUID(s). In addition, the football sensor transmits the active metric to user devices associated with the user(s) (matched to the UUID(s)).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A system, comprising:
(a) an object device affixed to a sports ball wherein the object device includes one or more object sensors;
(b) a player device affixed to at least one of a player and a player sports equipment wherein the player device includes one or more player sensors;
(c) wherein the object device: (i) detects the player device using the one or more object sensors and one or more player sensors; (ii) acquires player information from the player device.

2. The system, of claim 1, further comprising:
(a) a computer server system:
(i) receiving object sensor information and the player information from a transmission from the object device;
(ii) determining at least one of player statistics and player metrics based on processing the object sensor information and the player information.

3. The system of claim 2, further comprising:
(a) one or more user computing devices:
(i) receiving the at least one of players statistics and player metrics;
(ii) displaying the at least one of player statistics and player metrics on a user interface.

4. The system of claim 1, wherein the object sensors include a sensor selected from the group consisting of: a temperature sensor, a global position sensor, a pressure sensor, a magnetic field sensor, and an angular momentum sensor.

5. The system of claim 1, wherein the object device includes an apparatus selected from the group consisting of: a radio frequency identification (RFI[[C]]D) module, a near field communication (NFC) module, a transmit/receive module, a transceiver, a wireless transmitter, and a user interface.

6. The system of claim 1, further comprising a plurality of player devices individually affixed to a plurality of players or player sports equipment possessed by said plurality of players, wherein the plurality of players are interacting with the sports ball, and wherein the player information includes a unique universal identification (UUID) of the plurality of player devices.

7. (canceled)

8. The system of claim 2, wherein the object sensor information and the player information is sent to the computer server system from the object device using at least one of WiFi and Bluetooth technology.

9. The system of claim 1, wherein the object device detects and acquires the player information from the player device using at least one of a RFID and NFC technology.

10. The system of claim 6, wherein the object device recognizes a first UUID from a first player in possession of the sports ball, then recognizes a second UUID from a second player who later becomes in possession of the sports ball.

11. The system of claim 1, wherein the system lacks a sonar sweeping technology to detect the player device.

12. A method comprising:
(a) providing an object device affixed to a sports ball wherein the object device includes one or more object sensors;
(b) providing a player device affixed to at least one of a player and a player sports equipment wherein the player device includes one or more player sensors;
(c) instigating a game wherein one or more players interact with the sports ball;
(d) wherein the object device (i) detects the player device using the one or more object sensors and one or more player sensors; and (ii) acquires player information from the player device.

13. The method of claim 12, further comprising:
(a) providing a computer server system that
(i) receives object sensor information and the player information from the object device; and
(ii) determines at least one of player statistics and player metrics based on processing the object sensor information and the player information.

14. The method of claim 13, further comprising:
(a) providing one or more user computing devices that
(i) receives the at least one of players statistics and player metrics; and
(ii) displays the at least one of player statistics and player metrics on a user interface.

15. The method of claim 12, wherein the object sensors include a sensor selected from the group consisting of: a temperature sensor, a global position sensor, a pressure sensor, a magnetic field sensor, and an angular momentum sensor.

16. The method of claim 12, wherein the object device includes an apparatus selected from the group consisting of: a radio frequency identification (RFIC) module, a near field communication (NFC) module, a transmit/receive module, a transceiver, a wireless transmitter, and a user interface.

17. The method of claim 12, wherein a plurality of players are interacting with the sports ball during the game, and further comprising providing a plurality of player devices individually affixed to the plurality of players or player sports equipment possessed by said plurality of players, and wherein the player information includes a unique universal identification (UUID) of the plurality of player devices.

18. The method of claim 13, wherein the object sensor information and the player information is sent to the computer server system from the object device using at least one of WiFi and Bluetooth technology.

19. The method of claim 12, wherein the object device detects and acquires the player information from the player device using at least one of a RFID and NFC technology.

20. The method of claim 12, wherein the system lacks a sonar sweeping technology to detect the player device.

21. The method of claim 17, wherein the object device recognizes a first UUID from a first player in possession the sports ball, then recognizes a second UUID from a second player who later becomes in possession of the sports ball.
